(19) United States
(12) Patent Application Publication
(10) Pub. No.: US 2018/0371252 A1
(43) Pub. Date: Dec. 27, 2018

(54) PROCESS FOR MAKING LIGNIN COMPOSITION

(71) Applicant: REN FUEL K2B AB, Stockholm (SE)

(72) Inventors: Christopher CARRICK, Danderyd (SE); Joseph SAMEC, Stockholm (SE)

(73) Assignee: REN FUEL K2B AB, Stockholm (SE)

(21) Appl. No.: 15/777,694

(22) PCT Filed: Oct. 19, 2016
(86) PCT No.: PCT/EP2016/075056

§ 371 Date: May 21, 2018

(30) Foreign Application Priority Data
Nov. 20, 2015 (SE) 1551502-6
Jan. 13, 2016 (SE) 1650032-4

(51) Int. Cl. C08L 97/00; C10L 8/00; C08J 3/09; B01D 11/04

(52) U.S. Cl. CPC C08L 97/005; C10L 8/00; C08J 3/095; C08J 2397/00; B01D 11/0492; C10L 2200/0469; C08J 3/092

(57) ABSTRACT

The invention relates to a process for making a purified lignin composition comprising a carrier liquid suitable for processing in a refinery. It comprises providing an aqueous lignin composition comprising lignin, cooking chemicals and water and adding a carrier liquid to the aqueous lignin to provide an organic phase. Then all or substantially all the water is removed from the composition. The lignin composition is processed to make the lignin more soluble in the carrier liquid in order to transfer more of the lignin to the organic phase. Cooking chemicals are removed, suitably by of washing by liquid/liquid extraction using a washing liquid. Finally washing liquid is removed.

The present invention relates to processes for providing lignin based feedstock for refineries, and in particular to a composition suitable for direct inclusion in a refinery process.

### BACKGROUND OF THE INVENTION

There is an increasing interest in using biomass as a source for fuel production. Biomass includes, but is not limited to, plant parts, fruits, vegetables, processing waste, wood chips, chaff, grain, grasses, corn, com husks, weeds, aquatic plants, hay, paper, paper products, recycled paper and paper products, lignocellulosic material, lignin and any cellulose containing biological material or material of biological origin.

An important component of biomass is the lignin present in the solid portions of the biomass. Lignin comprises chains of aromatic and oxygenate constituents forming larger molecules that are not easily treated. A major reason for difficulty in treating the lignin is the inability to disperse the lignin for contact with catalysts that can break the lignin down.

Lignin is one of the most abundant natural polymers on earth. One common way of obtaining lignin is by separation from wood during pulping processes. Only a small amount (1-2%) is utilized in specialty products whereas the rest primary serves as fuel. Even if burning lignin is a valuable way to reduce usage of fossil fuel, lignin has significant potential as raw material for the sustainable production of chemicals and liquid fuels.

Various lignins differ structurally depending on raw material source and subsequent processing, but one common feature is a backbone consisting of various substituted phenyl propane units that are bound to each other via aryl ether or carbon-carbon linkages. They are typically substituted with methoxy groups and the phenolic and aliphatic hydroxyl groups provide sites for e.g. further functionalization. Lignin is known to have a low ability to adsorb water compared to for example the hydrophilic cellulose.

Today lignin may be used as a component in for example pellet fuel as a binder but it may also be used as an energy source due to its high energy content. Lignin has higher energy content than cellulose or hemicelluloses and one gram of lignin has on average 2.27 kJ, which is 30% more than the energy content of cellulosic carbohydrate. The energy content of lignin is similar to that of coal. Today, due to its fuel value lignin that has been removed using the Kraft process, sulphate process, in a pulp or paper mill, is usually burned in order to provide energy to run the production process and to recover the chemicals from the cooking liquor.

There are several ways of separating lignin from black or red liquor obtained after separating the cellulose fibres in the Kraft or sulphite process respectively, during the production processes. One of the most common strategies is membrane filtration. LignoBoost® is a separation process developed by Innventia AB and the process has been shown to increase the lignin yield using less sulphuric acid. In the LignoBoost® process, black liquor from the production processes is taken and the lignin is precipitated through the addition and reaction with acid, usually carbon dioxide (CO2), and the lignin is then filtered off. The lignin filter cake is then re-dispersed and acidified, usually using sulphuric acid, and the obtained slurry is then filtered and washed using displacement washing. The lignin is usually then dried and pulverized in order to make it suitable for lime kiln burners or before pelletizing it into pellet fuel.

Biofuel, such as biogasoline and biodiesel, is a fuel in which the energy is mainly derived from biomass material or gases such as wood, corn, sugarcane, animal fat, vegetable oils and so on. However the biofuel industries are struggling with issues like food vs fuel debate, efficiency and the general supply of raw material. At the same time the pulp or paper making industries produces huge amounts of lignin which is often, as described above, only burned in the mill. Two common strategies for exploring biomass as a fuel or fuel component are to use pyrolysis oils or hydrogenated lignin.

In order to make lignin more useful one has to solve the problem with the low solubility of lignin in organic solvents. One drawback of using lignin as a source for fuel production is the issue of providing lignin or lignin derivatives in a form suitable for hydrotreaters or crackers. The problem is that lignin is not soluble in oils or fatty acids which is, if not necessary, highly wanted.

Prior art provides various strategies for degrading lignin into small units or molecules in order to prepare lignin derivatives that may be processed. These strategies include hydrogenation, dexoygenation and acid catalyst hydrolysis. WO2011003029 relates to a method for catalytic cleavage of carbon-carbon bonds and carbon-oxygen bonds in lignin. US20130025191 relates to a depolymerisation and deoxygenation method where lignin is treated with hydrogen together with a catalyst in an aromatic containing solvent. All these strategies relates to methods where the degradation is performed prior to eventual mixing in fatty acids or oils. WO2008157164 discloses an alternative strategy where a first dispersion agent is used to form a biomass suspension to obtain a better contact with the catalyst. These strategies usually also requires isolation of the degradation products in order to separate them from unwanted reagents such as solvents or catalysts.

Applicants own WO 2015/094099 relates to a composition comprising a high content of lignin or lignin derivatives in a fatty acid, esterified fatty acid or oil and optionally an organic solvent as well. In order to obtain a high content of lignin it has to be functionalized or modified by e.g. esterification of the hydroxyl groups. One application for the composition may be as a raw material for fuel production or for the preparation of lubricating oils.

### SUMMARY OF THE INVENTION

In order to be usable as a feed-stock for refineries a lignin composition must be provided that is compatible with the process media in the refinery, and this requires that it is essentially water-free and essentially free from any residues of cooking chemicals when black liquor is used as raw material.

The object of the present invention is therefore to provide an improved process for making a lignin composition suitable for processing in a refinery, which meets the above requirements.

This object is met by the process defined in claim 1.

It comprises a process for making a purified lignin composition comprising a carrier liquid suitable for processing in a refinery. It comprises providing an aqueous lignin composition comprising lignin, cooking chemicals and water and adding a carrier liquid to the aqueous lignin to provide an organic phase. Then all or substantially all the water is removed from the composition. The lignin composition is processed to make the lignin more soluble in the carrier liquid in order to transfer more of the lignin to the organic phase. Cooking chemicals are removed, suitably by of washing by liquid/liquid extraction using a washing liquid. Finally washing liquid is removed.

In a further aspect of the invention a lignin composition obtainable by the process is provided.

Suitably the lignin composition is used in a refinery for making fuel.

Preferred embodiments are defined in the dependent claims.

Further scope of applicability of the present invention will become apparent from the detailed description given hereinafter and the accompanying drawings which are given by way of illustration only, and thus not to be considered limiting on the present invention, and wherein

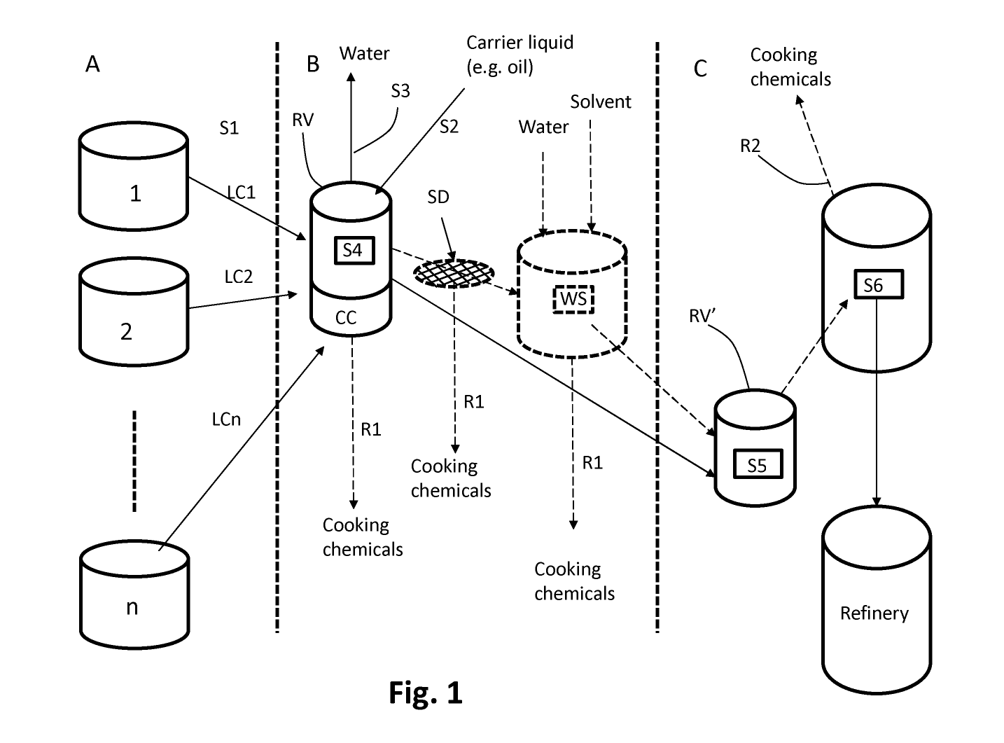

FIG. 1 shows the new process in a general overview;

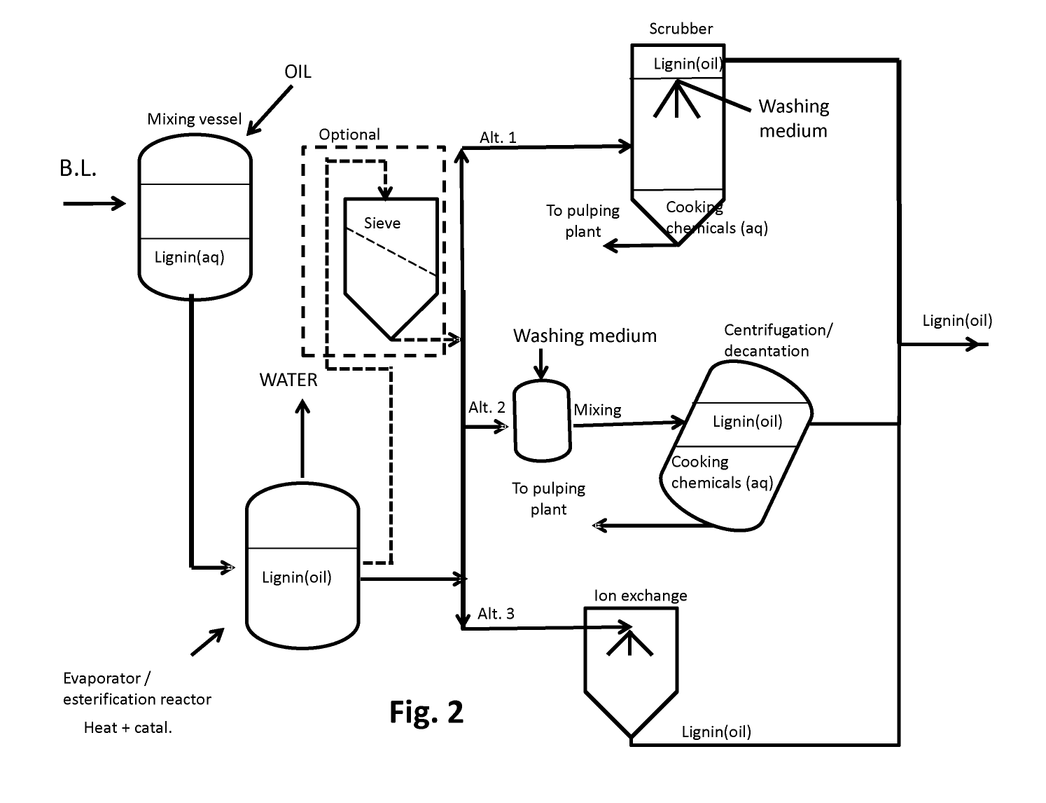

FIG. 2 is a schematic illustration of embodiments; and

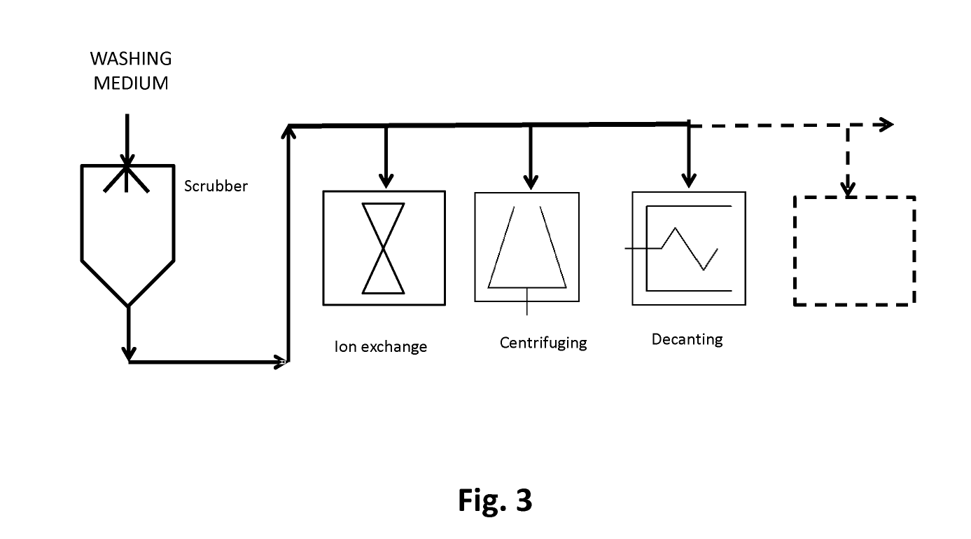

FIG. 3 is a schematic illustration of embodiments of a final washing step.

### DETAILED DESCRIPTION OF PREFERRED EMBODIMENTS

In the present application the term “lignin” means a polymer comprising coumaryl alcohol, coniferyl alcohol and sinapyl alcohol monomers. FIG. 8 discloses a schematic picture of a part of lignin.

In the present application the term “carrier liquid” means a liquid selected from fatty acids or mixture of fatty acids, esterified fatty acids, rosin acid, crude oil, mineral oil, bunker fuel and hydrocarbon oils or mixtures thereof.

In the present invention the term “oil” means a nonpolar chemical substance that is a viscous liquid at ambient temperature and is both hydrophobic and lipophilic. FIG. 1 is a schematic and generic illustration of the new process.

The schematic illustration is divided in three partitions, A, B and C, representing the claimed generic process. Partition A represents different kinds of preprocessing 1, 2, . . . n of a lignin solution (e.g. black liquor), the resulting product of which will be fed into the novel process. The different options represent different available methods for extracting lignin from the lignin solution (e.g. black liquor, acetosolv, organosolv, red or brown liquor), the result being an aqueous composition comprising lignin, cooking chemicals and water in various concentrations depending on the method used.

Thus, the first step S1 in the novel process, represented by the arrows LC1, LC2, . . . LCn, (where LC means “lignin composition) is to supply a suitable reactor vessel RV with a lignin composition with the specified constituents.

In a second step S2 (in partition B) a carrier liquid (for example an oil or a fatty acid) is added to this starting composition to provide an organic phase. A minor fraction of the lignin will dissolve in this organic phase, another fraction might precipitate, but the major portion will remain in the aqueous phase. Thus, what we have now is a two or three-phase system, i.e. two liquid phases and a possibly solid phase, with lignin and cooking chemicals dissolved in an aqueous phase, an organic phase with some lignin dissolved and possibly a lignin chemical precipitate. The precipitated lignin may comprise cooking chemicals associated to the precipitated lignin.

In the method according to the present invention a carrier liquid is used, for example an oil. The carrier liquid may be any suitable oil for example a hydrocarbon oil, crude oil, bunker oil, mineral oil, tall oil, creosote oil, tar oil, fatty acid or esterified fatty acid. In one embodiment the carrier liquid is a fatty acid or a mixture of fatty acids. The fatty acid may be a tall oil fatty acid (TOFA). In another embodiment the carrier liquid is esterified fatty acids such as FAME (fatty acid methyl ester) or triglyceride. In one embodiment the carrier liquid is a crude oil. In one embodiment the carrier liquid is bunker fuel or bunker crude. In another embodiment the carrier liquid is a hydrocarbon oil or a mineral oil. In one embodiment the carrier liquid is a mixture of esterified fatty acid and a mineral oil, hydrocarbon oil, bunker fuel or crude oil. In another embodiment the carrier liquid is a mixture of a hydrocarbon oil or a mineral oil and a fatty acid. In one embodiment the carrier liquid is creosote oil or tar oil. Since the composition may be used for preparing fuels the carrier liquid does not have to be an already hydrotreated or cracked liquid such as diesel, instead the carrier liquid should be a liquid that may be hydrotreated or cracked in a refinery process in order to form a fuel. By using a non-hydrotreated or non-cracked carrier liquid conventional refinery processes may be used and carrier liquids that any way would be refined can be used.

When the carrier liquid is or comprises a hydrocarbon oil the carrier liquid needs to be in liquid phase below 80° C. and preferably have boiling points of 177-371° C. These hydrocarbon oils include different types of or gas oils and likewise e.g. light cycle oil (LCO), Full Range Straight Run Middle Distillates, Hydrotreated, Middle Distillate, Light Catalytic Cracked Distillate, distillates Naphtha full-range straight-run, hydrodesulfurized full-range, solvent-dewaxed straight-range, straight-run middle sulfonylated, Naphtha clay-treated full-range straight run, distillates full-range atm, distillates hydrotreated full-range, straight-run light, distillates heavy straight-run, distillates (oil sand), straight-run middle-run, Naphtha (shale oil), hydrocracked, full-range straight run (example of but not restricted to CAS nr: 68476-30-2, 68814-87-9, 74742-46-7, 64741-59-9, 64741-44-2, 64741-42-0, 101316-57-8, 101316-58-9, 91722-55-3, 91995-58-3, 68527-21-9, 128683-26-1, 91995-46-9, 68410-05-9, 68915-96-8, 128683-27-2, 195459-19-9). In one embodiment the hydrocarbon oil is a gas oil such as light gas oil (LGO).

Organic solvents that are similar to or may be converted into fuel or petrol may be added as well. They are interesting since any residues of the organic solvent will not have any negative effect on the subsequent refinery process. Such solvents could be ketones or aldehydes. In one embodiment the solvent is a C2-C15 ketone such as a C4-C12 ketone or a C6-C8 ketone. In one embodiment the solvent is a C1-C10 aldehyde such as a C4-C9 aldehyde or C6-C8 aldehyde. In one embodiment the solvent is a mixture of a C2-C15 ketone and a C1-C10 aldehyde. A non-limiting list of solvents is mesityl oxide, acetone, acetophenone, pentanone, ethyl isopropyl ketone, isophorone, furfural, benzaldehyde or ethyl acetate. These may also be used for washing the organic phase.

Next, in step S3, water is removed, by a suitable method such as heating, evaporation, osmosis, membrane filtration, decanting process, centrifugation or any other feasible method. Preferably at least 90%, more preferred more than 95% of the water, even more preferred more than 99% of the water is removed. When removing the water by heating or evaporation a substantial portion of the cooking chemicals CC precipitate, schematically shown at the bottom of the reactor vessel RV. Also depending on the method of removing the water, for example heating or evaporation, the lignin dissolved in water will precipitate when water is removed.

It is now desirable to transfer the carrier liquid insoluble lignin, which as mentioned is a major part of the lignin, to the organic phase. This can be done by modifying the lignin such as by alkylation (e.g. esterification, etherification or amidation), deoxygenation, depolymerization or hydrogenation or protonation of the lignin, schematically indicated with reference S4. Hydrogenation or protonation is performed preferably using a catalyst, such as transition metal catalysts for example Pt, Pd, Raney Nickel or Ni on zeolites. Methods usable for this step are disclosed in applicants own WO 2014/039002 A1. The lignin becomes less water soluble, and instead it will be hydrophobic and therefore it will dissolve in the organic phase.

As described in WO2015/094099 the present inventors found that by esterifying the hydroxyl groups of the lignin or lignin derivatives the solubility of the lignin increased drastically. A lignin composition may be prepared by first preparing the esterified lignin or lignin derivative and then mixing said esterified lignin with a carrier liquid or solvent. A suitable carrier liquid is fatty acid or esterified fatty acid, or a mixture of fatty acid and a hydrocarbon oil. The esterified lignin may be isolated from the esterification reaction mixture or the esterified lignin is left in the reaction mixture when mixed with the carrier liquid or solvent. The esterification of the lignin may also be performed in situ, i.e. in the carrier liquid or solvent. Then the lignin, the esterification agent or, the first fatty acid and an esterification agent, and the carrier liquid (or solvent) and optionally a catalyst are mixed to form a slurry or mixture. The slurry or mixture is then preferably heated between 50° C. and 350° C., such as 50° C. or higher, or 80° C. or higher or 100° C. or higher, or 120° C. or higher, or 150° C. or higher, but not higher than 350° C., or 250° C. or lower, or 200° C. or lower, or 180° C. or lower. The esterification agent may be a carboxylic acid or an anhydride. The esterification agents preferably contain an unsaturated bond. Non-limiting examples of carboxylic acids are fatty acids or C2-C42 carboxylic esters, preferably C4 to C22 such as C18, and non-limiting examples of anhydrides are C4 to C42 anhydrides. The catalyst for the esterification may be a nitrogen containing aromatic heterocycle such as N-methyl imidazole or pyridine, or the catalyst may be a metal acetylacetonate such as TiO(acac)2 or Fe(acac)3.

It should be noted that for the esterification and the etherification of the lignin, it is required that the lignin is in protonated form in order for the esterification to be performed in a carrier liquid. In the black liquor the lignin is present primarily in a salt form, and thus it has to be treated with an acid or carbon dioxide so as to lower the pH, in order that the esterification and/or etherification can be performed successfully. Suitably the pH is adjusted to pH 9 or lower, preferably to pH 4 or lower.

Suitable acids are selected in dependence of the desired pH, where acids can be selected from the group consisting of sulfuric acid or formic acid.

When the modification of the lignin is done by etherification the modification agent may be an epoxide. The epoxide can be an alkyl epoxide for example a C5 or longer alkyl epoxide, or a C12 or longer alkyl epoxide, or C18 or longer alkyl epoxide. It could alternatively be a fatty acid epoxide. The etherification may be performed at 80° C. or higher, or 120° C. or higher, or 150° C. or higher, or 180° C. or higher, preferably at 350° C. or lower, or at 250° C. or lower, or at 200° C. or lower.

The precipitated cooking chemicals can now be separated from the organic phase which contains the lignin. Such separation can be performed in a number of ways, which will be disclosed in greater detail below.

The separated cooking chemicals are preferably returned (dashed arrow R1) to the pulping process whereby the economy of the over-all process is considerably improved.

The lignin composition now comprising modified lignin dissolved in an organic phase and possibly some residual water and cooking chemicals (CC) is now preferably subjected to a further washing step S5 using an aqueous medium, preferably an aqueous acid or a ligand/chelating solution (e.g. EDTA), in order to remove CC, metal ions and electrostatically bound metal ions from the lignin. The washing is suitably performed as a liquid/liquid extraction, e.g. in a scrubber or by mixing water with the carrier liquid so that the CC goes to the water phase.

This step S5 is illustrated as being performed in a separate unit RV′. This is not strictly necessary, and the washing can be performed in the same reactor RV as the previous treatments, but for easy explanation it is shown in this way.

The washing step S5 can itself be subdivided in a number of different washing steps using the same or different media (e.g. displacement washing), such as pure water, various concentrations of aqueous acid, or other solvents capable of dissolving and removing the CC from the organic phase. Depending on the sequence of washing steps and the use of selected media different qualities of the final product can be arrived at. The washing media may be reused for washing for example after removal of the CC which preferably is returned to the pulp mill recovery boiler.

By quality in this context we mean the level of cooking chemicals/water in the product resulting from the process.

The result of the washing process is a product that may or may not require further processing before it is delivered for a specified use.

To be able to use the product, in a preferred embodiment, as a feed-stock and/or supplement in a refinery process, water has to be essentially removed. Preferably the water concentration is below 300 ppm. Thus, if there is still water present in the lignin composition, this water needs to be removed and in the process of removing the water, schematically indicated at S6, also any residual cooking chemicals dissolved in the water will also be recovered and returned R2 to the pulping process.

Suitably the water removal is achieved by a decanting procedure, by centrifugation, by membrane filtration, by ion exchange or by evaporation.

Now some embodiments will described in terms of alternatives for the various sub-steps in the generic process described above.

Thus, the step of removing the precipitated cooking chemicals CC after the lignin has been transferred to the organic phase in step S4, can be implemented in different ways.

One way is to use physical separation e.g. by using a sieve type device, schematically indicated by reference SD, to separate the precipitated solid material.

Another method is to employ a washing step WS, schematically indicated by the arrows/vessel in broken line contour in partition B. Here, the idea is to dissolve the precipitated cooking chemicals by adding water or any other suitable solvent and then remove the solution by e.g. decanting, centrifugation or any other suitable method.

Here it can also be beneficial to the process when the lignin has been esterified to use a solvent less nucleophilic than water for example an alcohol for example methanol or ethanol.

In order to improve the washing step, the organic lignin phase can be diluted by a carrier liquid, e.g. an oil, having a lower viscosity and/or a lower melting point temperature to reduce the viscosity and/or the melting point temperature of the composition. This dilution will for example enable an improved contact between the carrier liquid and the washing liquid at the mixing step at a given temperature and mixing shear rate because of a decreased viscosity of the lignin containing organic phase. It would presumably enable a washing step carried out at lower temperatures due to the decreased melting point. Furthermore, an increased rate of separation at a given temperature is also expected due to the decreased viscosity and increased mobility of the lignin containing organic phase.

The washing step S5 could be implemented in different ways, as mentioned above.

For example a column type process could be used, suitably in a counter current manner. Thereby, the lignin composition would be fed into a scrubber at one end thereof and washing liquid, e.g. water, would be fed from the other direction. The scrubber can be provided with a plurality of inlets for different washing liquids having different pH and ligand/chelating concentration, in order to treat the CC, metal ions and electrostatically bound ions present in the lignin material.

It is also conceivable to employ an ion exchange type process for this step S5.

The input or feed-stock (LC1, LC2, . . . LCn) for the present process is a lignin composition that can be obtained in several different ways.

One possibility is to subject black liquor to a membrane filtering process, for which the present applicants have filed a patent application, WO2015/137861, the disclosure of which is hereby incorporated in its entirety. In this way a much narrower molecular distribution is obtained, which can be better suited for the end use in e.g. a refinery.

The process involves subjecting the lignin composition to a series of membrane filtration steps in order to dispose of both the very high molecular fractions and the very low molecular fractions, so as to provide a composition that is well suited for e.g. use in a refinery. The output from this process typically has 30-50% lignin(aq), 1-10% cooking chemicals and the balance (40-9%) water.

Another method is a commercially available process, LignoBoost®, which is also subject to patent protection, e.g. EP1794363. This process yields a composition with very low content of cooking chemicals. It entails a precipitation followed by an acid treatment. Thus the acid consumption in the overall process will be rather high. The output from this process typically has 65% lignin(aq), <5% cooking chemicals and the balance (about 30-34%) water.

Another method simply involves precipitation and has been known for many decades, and the LignoBoost process is a development of such precipitation method. The output from this process typically has 65% lignin(aq), 5-10% cooking chemicals and the balance (25-30%) water.

Still another method provides a liquid lignin. However, this is only achievable under elevated pressures, and thus the process has to be integrated in a plant for performing the method disclosed in this application. The output from this process typically has 60% lignin (aq), 10% cooking chemicals and 30% water.

The simplest method is to utilize evaporated black liquor. Evaporation of black liquor already takes place at all pulping plants for recovery purposes, and yields an output product typically having 65-80% dry matter, wherein lignin(aq) accounts for about 50% (i.e. about 32-40% of the total composition), cooking chemicals accounts for about 50% (i.e. about 32-40% of the total composition), and the balance (i.e. 20-35%) water.

Thus, generally speaking the aqueous lignin composition comprises at least 30% by weight lignin, preferably at least 40, more preferred 50% by weight lignin, less than 40% by weight cooking chemicals, preferably less than 20% by weight, most preferred between 1 and 10% by weight, and the balance water.

Embodiments of a system for performing the various alternatives of the method disclosed above will now be given with reference to FIG. 2.

Thus, FIG. 2 is a process set up comprising a mixing vessel to which black liquor in an aqueous phase containing cooking chemicals and lignin is input as raw material. A suitable oil, such as a gas oil or triglycerids or a fatty acid is fed into the mixing vessel suitably under stirring, whereby two phases are obtained, an organic phase and an aqueous phase. Some of the low molecular lignin will dissolve in the organic phase already at this point whereas most of the lignin remains in the aqueous phase. In this embodiment the two phase system is transferred to a reactor suitable as an evaporator and as an esterification reactor.

Thus, in a first step in this reactor water is removed by evaporation to get rid of most of the water. Cooking chemicals and the dissolved lignin will precipitate in solid or crystalline form.

In a second step the lignin is modified for example by esterification. In one embodiment an esterification agent (e.g. an anhydride) and optionally a catalyst (e.g. N-methyl imidazole) are added and heat is applied, in order to induce an esterification process. Thereby the lignin will become hydrophobic and most of the lignin will therefore dissolve in the organic phase, whereas the cooking chemicals are unaffected and remains in solid, precipitated form.

In an optional step, the content of the reactor is passed through a sieve in order to separate the precipitated cooking chemicals. This optional step is indicated by a box with broken lines. The separated material is transferred back to the pulping plant for reuse (as shown at R1 in FIG. 1), whereby the economy of the process is greatly improved.

For the continued processing there are a number of alternatives.

In Alternative 1 in FIG. 2, the carrier liquid and lignin composition (referred to as Lignol®) is transferred to a scrubber for washing.

The scrubber can be operated in several steps using different washing media, suitably beginning with water or an organic solvent, and subsequently increasingly acidic media are used for washing, such as weakly acidic (H₂CO₃) in the first stages and ending with strongly acidic (H₂SO₄).

Alternative 2 comprises washing the lignin composition in a mixing process and using centrifugation and/or decantaion to separate out the desired fraction, whereby the precipitated cooking chemicals are dissolved again and then the organic phase can be decanted off. This is schematically illustrated by showing the vessel in a tilting position. In this embodiment it has been discovered that addition of a suitable solvent for the lignin such as an alcohol is beneficial.

In Alternative 3 an ion exchange process in a column type device is used for separating out the desired fraction.

It is also possible to combine these alternatives such that e.g. after the ion exchange process a washing/centrifugation/decanting can be performed.

The washed lignin in organic phase is passed to a scrubber as in the previous embodiment for further purification.

After the washing treatment in the scrubber or mixing any residual water remaining in the composition is preferably removed prior to use in e.g. a refinery.

Thus, the washed composition is subjected to some further treatments such as evaporation, centrifuging or decanting, or a combination, schematically illustrated in FIG. 3. Other methods can also be used in combination with the ones shown in FIG. 3, and this is illustrated with an empty box in broken lines.

1. Process for making a purified lignin composition comprising a carrier liquid suitable for processing in a refinery, comprising
providing an aqueous lignin composition comprising lignin, cooking chemicals and water;
adding a carrier liquid to the aqueous lignin to provide an organic phase,
removing all or substantially all the water from the composition, preferably at least 90%, more preferred more than 95% of the water, even more preferred more than 99% of the water, suitably by any of heating, evaporation, osmosis, membrane filtration;
processing said lignin composition to make the lignin more soluble in the carrier liquid in order to transfer more of the lignin to the organic phase,
optionally removing cooking chemicals that have precipitated by physical separation,
removing cooking chemicals comprises a step of washing by liquid/liquid extraction using a washing liquid; and
removing washing liquid.

2. Process according to claim 1, wherein the washing liquid is water.

3. Process according to claim 1, wherein the physical separation of any precipitated cooking chemicals before the washing step is performed by sieving, filtration or centrifugation.

4. Process according to claim 1, wherein a carrier liquid, e.g. an oil, is added under mixing to enable an improved washing step.

5. Process according to claim 1, wherein the processing to make lignin water insoluble comprises esterification, etherification, hydrogenation or protonation.

6. Process according to claim 2, comprising a washing step after removing cooking chemicals, said washing step comprising a plurality of sub-steps with different washing media, such as water, weak acid, strong acid, chelating agents, ligands or other solvents where the cooking chemicals are dissolved or removed.

7. Process according to claim 6, further comprising separating any remaining water and residual solids/cooking chemicals from the washed composition to obtain an essentially water free lignin containing solution of lignin in an organic phase, suitably by decanting or evaporation.

8. Process according to claim 6, wherein said washing step comprises a liquid-liquid extraction process.

9. Process according to claim 1, wherein the aqueous lignin composition comprises at least 30% by weight lignin, preferably at least 40, more preferred 50% by weight lignin, less than 40% by weight cooking chemicals, preferably less than 20% by weight, most preferred between 1 and 10% by weight, and the balance water.

10. Process according to claim 5, wherein the process comprises esterification.

11. Process according to claim 5, wherein the process comprises etherification.

12. Process according to claim 1, wherein the carrier liquid is fatty acid or esterified fatty acid.

13. Process according to claim 1, wherein the carrier liquid is a hydrocarbon oil.

14. Lignin composition obtainable with the process according to claim 1.

15. Use of a lignin composition for making fuel.
